(19) United States
(12) Patent Application Publication
(10) Pub. No.: US 2013/0173580 A1
(43) Pub. Date: Jul. 4, 2013

(54) SCENARIO-BASED CRAWLING

(71) Applicants: IGAL KREICHMAN, HAIFA (IL); OMER TRIPP, HERZELYIA (IL)

(72) Inventors: IGAL KREICHMAN, HAIFA (IL); OMER TRIPP, HERZELYIA (IL)

(73) Assignee: INTERNATIONAL BUSINESS MACHINES CORPORATION, ARMONK, NY (US)

(21) Appl. No.: 13/412,295

(22) Filed: Mar. 5, 2012

Related U.S. Application Data
(63) Continuation of application No. 13/338,815, filed on Dec. 28, 2011.

(51) Int. Cl. G06F 17/30

(52) U.S. Cl. 707/709; 707/E17.108

(57) ABSTRACT

An interactive session can be established between a crawling bot and a Web site. The crawling bot can defines a session state representing a user state for interacting with one or more Web sites, a set of conditions, and a set of scenarios to be selectively activated based on whether the set of conditions are satisfied. The crawling bot can receive content from the Web site during the interactive session. The crawling bot can parse the content from the Web site and can matching the parsed content against a previously defined set of items to determine whether the content matching condition is satisfied. If the content matching condition is satisfied and if the state condition is satisfied, the crawling bot, activating of the scenarios defined by the crawling bot can be active, which is not activated if the content matching condition and the state condition are not satisfied.

### CROSS REFERENCE TO RELATED APPLICATIONS

This application is a continuation of U.S. patent application Ser. No. 13/338,815, filed Dec. 28, 2011 (pending), which is incorporated herein in its entirety.

### BACKGROUND

The present invention relates to automated interaction with computer software applications and, more particularly, to automated crawling of computer-based documents or software applications.

Automated software tools have long been used to autonomously interact with computer software applications, such as to discover the various components of an application for mapping purposes. For example, one such tool, commonly known as a “crawler,” is often used to navigate a web site by traversing its web pages and other computer-based documents along hyperlinks, such as Universal Resource Locators (URLs), embedded in the documents that indicate the locations of other documents.

Current crawlers typically operate at the level of the Hypertext Transport Protocol (HTTP) by sending HTTP requests and using the resulting HTTP responses to generate more requests. These crawlers can operate without reasoning about the meaning of the actions represented by the requests, the ordering constraints between these actions, and the expected result of performing each action.

### BRIEF SUMMARY

In one aspect of the disclosure, a method, system, computer program product, and/or apparatus for web crawling Web-based content is provided. In the embodiment, an interactive session can be established between a crawling bot and a Web site. The crawling bot can defines a session state representing a user state for interacting with one or more Web sites, a set of conditions, and a set of scenarios to be selectively activated based on whether the set of conditions are satisfied or not. The set of conditions can include a state condition for whether the user state is equal to a preconfigured value or not. The set of conditions also includes a content matching condition. The crawling bot can receive content from the Web site during the interactive session. The crawling bot can parse the content from the Web site and can matching the parsed content against a previously defined set of items to determine whether the content matching condition is satisfied or not. If the content matching condition is satisfied and if the state condition is satisfied, the crawling bot, activating of the scenarios defined by the crawling bot can be active, which is not activated if the content matching condition and the state condition are not satisfied.

In one aspect of the disclosure, a method, system, computer program product, and/or apparatus is provided for scenario-based crawling. The method can selecting a predefined scenario where each of the characteristics in a predefined set of pre-interaction characteristics associated with the scenario is present at a point during a crawling session. The method can perform upon a current object of the crawling session each of the interactions in a predefined set of interactions associated with the scenario. The method can also identify which of the characteristics in a predefined set of post-interaction characteristics associated with the scenario are present during the crawling session subsequent to performing the interactions. A current state of the crawling session can be determined as being a predefined state that is associated with any of the post-interaction characteristics that are present during the crawling session subsequent to performing the interactions.

In other aspects of the disclosure systems, apparatuses, and/or computer program products performing the above method and/or that are used in conjunction with the method are detailed.

### BRIEF DESCRIPTION OF THE SEVERAL VIEWS OF THE DRAWINGS

FIG. 1 is a simplified conceptual illustration of a system for scenario-based crawling, constructed and operative in accordance with an embodiment of the disclosure;

FIG. 2 is a simplified flowchart illustration of a method of operation of the system of FIG. 1, operative in accordance with an embodiment of the disclosure;

FIG. 3 is a simplified flowchart illustration of an method of operation of the system of FIG. 1, operative in accordance with an embodiment of the disclosure; and

FIG. 4 is a simplified block diagram illustration of a hardware implementation of a computing system, constructed and operative in accordance with an embodiment of the disclosure.

### DETAILED DESCRIPTION

The disclosure is now described within the context of one or more embodiments, although the description is intended to be illustrative of embodiments of the invention as a whole, and is not to be construed as limiting other embodiments of the invention to the embodiments shown. It is appreciated that various modifications may occur to those skilled in the art that, while not specifically shown herein, are nevertheless within the true spirit and scope of the invention.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

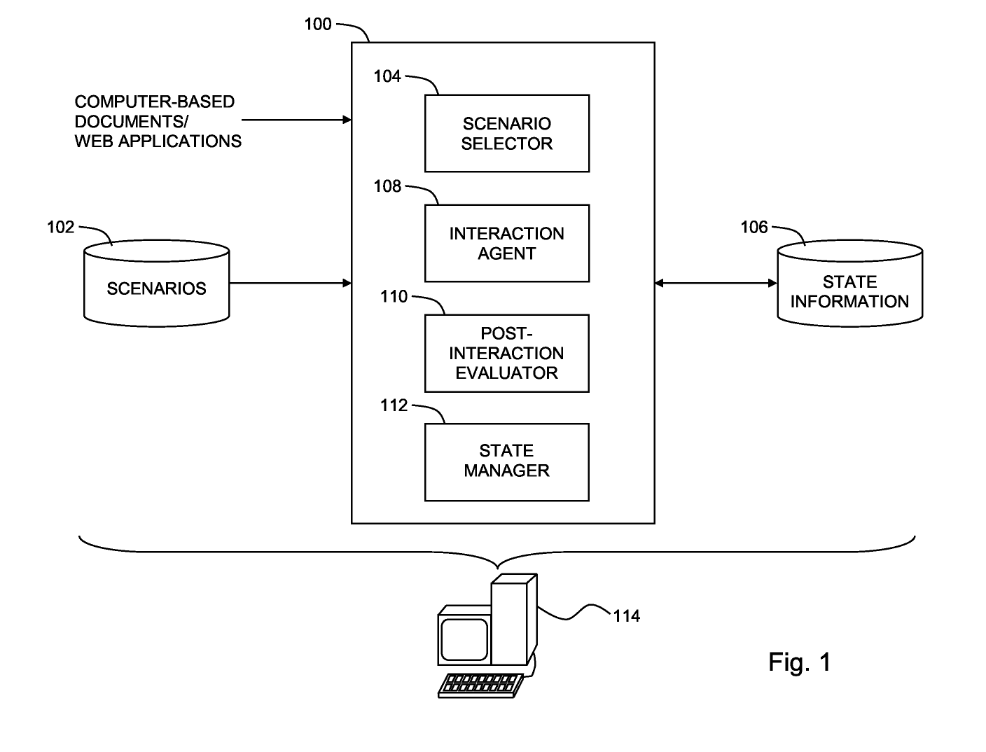

Reference is now made to FIG. 1, which is a simplified conceptual illustration of a system for scenario-based crawling, constructed and operative in accordance with an embodiment of the invention. In the system of FIG. 1, a crawler 100 is configured to crawl computer-based documents or software applications in accordance with conventional techniques, and is additionally configured to operate as described herein below. A set of one or more scenarios 102 is defined such that each scenario includes the following:
a predefined set of pre-interaction characteristics;
a predefined set of interactions;
a predefined set of post-interaction characteristics; and/or
a predefined set of states, where each state is associated with one or more of the post-interaction characteristics.

Crawler 100 preferably includes, or is otherwise configured to cooperate with, a scenario selector 104 that is configured to select one or more of the scenarios 102, where a scenario is selected if each of the characteristics in the predefined set of pre-interaction characteristics associated with the scenario are present at a point during a crawling session, such as after receiving a web page from a web application during a crawling session of the web application. Thus, for example, if the scenario's set of pre-interaction characteristics includes the characteristics <LoggedIn=‘Yes’> and <CurrentWebPage includes ‘Logout’ button>, scenario selector 104 preferably checks a data store of state information 106 that is maintained of the crawling session during the crawling session to determine whether the user associated with the session, such as represented by crawler 100, is currently logged in to the web application, and checks whether the current web page provided by the web application includes a button labeled “Logout”. If each of the characteristics are present, then scenario selector 104 selects the scenario.

Crawler 100 also preferably includes, or is otherwise configured to cooperate with, an interaction agent 108 that is configured to perform each of the interactions in the scenario's predefined set of interactions with a current object of the crawling session, such as with the received web page. Thus, continuing with the current example, the set of interactions may include the interaction <Press the “Logout” button>, which interaction agent 108 then performs with the received web page.

Crawler 100 also preferably includes, or is otherwise configured to cooperate with, a post-interaction evaluator 110 that is configured to identify which of the scenario's post-interaction characteristics are present during the crawling session subsequent to interaction agent 108 performing the interactions in the scenario's predefined set of interactions. Thus, continuing with the current example, if the set of post-interaction characteristics includes the characteristic <CurrentWebPage includes “Thank you”>, post-interaction evaluator 110 preferably evaluates a web page returned by the web application in response to pressing the “Logout” button to determine if the returned web page includes the phrase “Thank you”. Post-interaction evaluator 110 may identify which of the post-interaction characteristics are present in any responses elicited by the interactions and/or in state information 106.

Crawler 100 also preferably includes, or is otherwise configured to cooperate with, a state manager 112 that is configured to determine a current state of the crawling session, where the current state is associated with any of the scenario's post-interaction characteristics that are determined by post-interaction evaluator 110 to be present during the crawling session. Thus, continuing with the current example, if post-interaction evaluator 110 determines that the characteristic <CurrentWebPage includes “Thank you”> is present in the web page returned by the web application in response to pressing the “Logout” button, and a state of <LoggedIn=‘No’> is associated with the scenario's post-interaction characteristic <CurrentWebPage includes “Thank you”>, state manager 112 may determine that the state of the user associated with the crawling session is <LoggedIn=‘No’>, and may record this information in state information 106.

It will be appreciated from the current example that, rather than crawling a web application randomly or based on heuristics, the system of FIG. 1 may be used to enable a crawler to interact with a web application intelligently by ensuring that the crawler presses a “Logout” button on a web page only if the crawler is currently logged in to the web application.

The system of FIG. 1 may be used to crawl computer-based documents or software applications using scenario-based interactions as described above where predefined scenarios are applicable, or using conventional techniques otherwise.

Any of the elements shown in FIG. 1 are preferably implemented by one or more computers, such as a computer 114, by implementing the elements in computer hardware and/or in computer software embodied in a non-transient, computer-readable medium in accordance with conventional techniques.

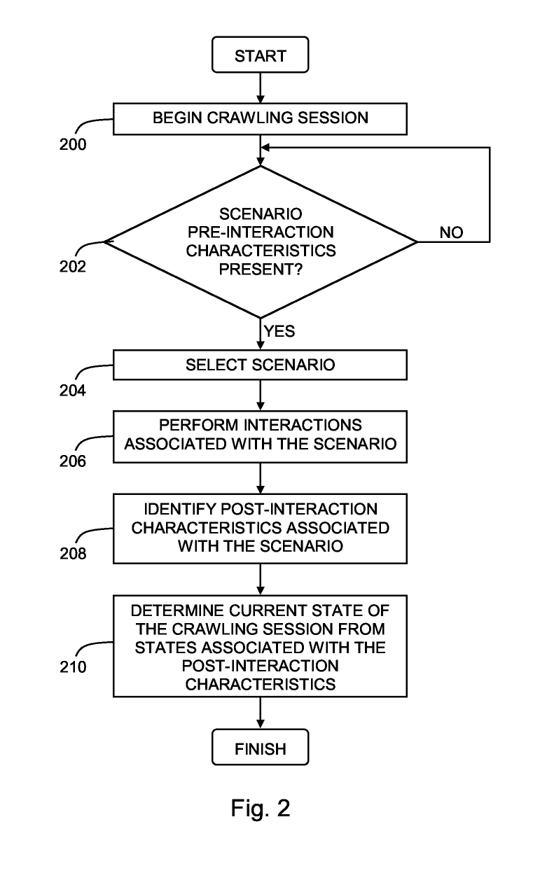

Reference is now made to FIG. 2, which is a simplified flowchart illustration of an exemplary method of operation of the system of FIG. 1, operative in accordance with an embodiment of the invention. In the method of FIG. 2, a crawling session is begun with respect to a set of computer-based documents and/or a software application (step 200). At any point during the crawling session, if each of the pre-interaction characteristics associated with a predefined scenario are present (step 202), the scenario is selected (step 204). Each of the interactions in a predefined set of interactions associated with the scenario is performed (step 206). Any post-interaction characteristics associated with the scenario, and that are present during the crawling session subsequent to performing the interactions, are identified (step 208). A current state of the crawling session is determined from a predefined set of states associated with any of the scenario's post-interaction characteristics that are present during the crawling session subsequent to performing the interactions (step 210).

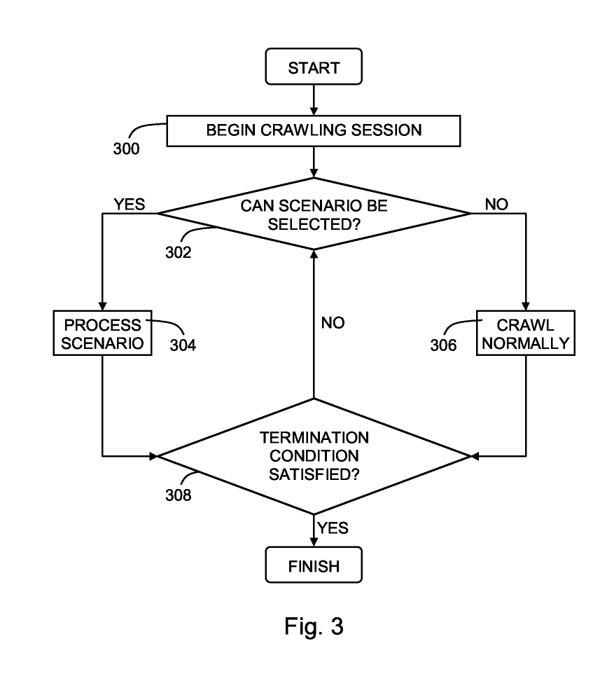

Reference is now made to FIG. 3, which is a simplified flowchart illustration of an exemplary method of operation of the system of FIG. 1, operative in accordance with an embodiment of the invention. In the method of FIG. 3, a crawling session is begun with respect to a set of computer-based documents and/or a software application (step 300). At any point during the crawling session, if a scenario can be selected (step 302), such as in accordance with the method of FIG. 2, then the scenario is processed (step 304), such as in accordance with the method of FIG. 2, and if a scenario cannot be selected, such as where each of the pre-interaction characteristics associated with a predefined scenario are not present, then crawling may be performed in accordance with conventional techniques (step 306). The crawling session may be terminated if a termination condition is satisfied (step 308).

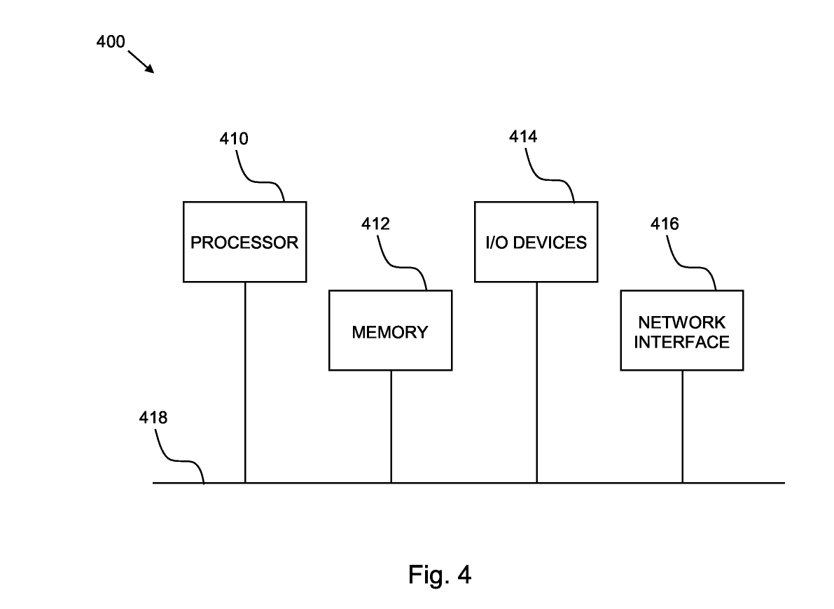

Referring now to FIG. 4, block diagram 400 illustrates an exemplary hardware implementation of a computing system in accordance with which one or more components/methodologies of the invention (e.g., components/methodologies described in the context of FIGS. 1-3) may be implemented, according to an embodiment of the invention.

As shown, the techniques for controlling access to at least one resource may be implemented in accordance with a processor 410, a memory 412, I/O devices 414, and a network interface 416, coupled via a computer bus 418 or alternate connection arrangement.

In one embodiment, the crawling session is between a crawling bot and a Web site (or other addressable Web-based resource). As used herein crawling refers to Web crawling that is conducted by a Web crawler or a crawling bot. The crawling bot is an autonomous or semi-autonomous software application able to interact with one or more Web sites in a methodical, automated manner or in an orderly fashion. Other commonly utilized terms for a crawling bot include ants, automatic indexers, bots, Web spiders, Web robots, and/or Web scutters. Web crawling is a means for providing up-to-date data concerning the Web, which can be used by other programs, such as search engines.

In one embodiment, the disclosed crawling bot can be used to create a copy of all the visited pages for later processing by a search engine that will index the downloaded pages to provide fast searches. Crawling bots can also be used for automating maintenance tasks on a Web site, such as checking links or validating HTML code. Also, the crawling bots can be used to gather specific types of information from Web pages, such as harvesting e-mail addresses.

In one embodiment, unlike conventional Web crawlers, the disclosed crawling bots can interact with Web sites that provide dynamic content. That is, the crawling bots can determine a Web site state relevant to the dynamic content, and can initiate actions (e.g., activate scenarios) that are specific to this state. For example, the crawling bots can provide previously defined input to the Web site to effectuate a change in the dynamic content of the Web site. For example, the Web crawlers can detect a current Web site state indicates a user is not logged in, then provide input to change the state of the Web site to a logged in state. The Web bots can effectuate actions specific to a Web site state, then parse received Web site content, and compare this content against expected outcomes—taking variable actions depending on whether the returned outcomes were satisfied or not. In other words, the crawling bots can introduce logical behavior to simulate user interactions for different window states.

This makes the disclosed crawling bots significantly more efficient for programmable purposes compared to conventional Web crawlers, as the crawling bots can be programmed for specific functions achievable without exhausting a set of possibilities of a given Web site. Further, the disclosed crawling bots can gather information not possible using conventional Web crawlers, as the crawling bots can provide input to trigger changes in dynamic content of Web sites, Web applications, or Web services.

It is to be appreciated that the term “processor” as used herein is intended to include any processing device, such as, for example, one that includes a CPU (central processing unit) and/or other processing circuitry. It is also to be understood that the term “processor” may refer to more than one processing device and that various elements associated with a processing device may be shared by other processing devices.

The term “memory” as used herein is intended to include memory associated with a processor or CPU, such as, for example, RAM, ROM, a fixed memory device (e.g., hard drive), a removable memory device (e.g., diskette), flash memory, etc. Such memory may be considered a computer readable storage medium.

In addition, the phrase “input/output devices” or “I/O devices” as used herein is intended to include, for example, one or more input devices (e.g., keyboard, mouse, scanner, etc.) for entering data to the processing unit, and/or one or more output devices (e.g., speaker, display, printer, etc.) for presenting results associated with the processing unit.

The flowchart and block diagrams in the Figures illustrate the architecture, functionality, and operation of possible implementations of systems, methods and computer program products according to various embodiments of the invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It will be appreciated that any of the elements described hereinabove may be implemented as a computer program product embodied in a computer-readable medium, such as in the form of computer program instructions stored on magnetic or optical storage media or embedded within computer hardware, and may be executed by or otherwise accessible to a computer (not shown).

While the methods and apparatus herein may or may not have been described with reference to specific computer hardware or software, it is appreciated that the methods and apparatus described herein may be readily implemented in computer hardware or software using conventional techniques.

While the invention has been described with reference to one or more specific embodiments, the description is intended to be illustrative of the invention as a whole and is not to be construed as limiting the invention to the embodiments shown. It is appreciated that various modifications may occur to those skilled in the art that, while not specifically shown herein, are nevertheless within the true spirit and scope of the invention.

What is claimed is:

1. A method comprising:
establishing, via at least one processor executing program instructions stored on at least one storage device, an interactive session between a crawling bot and a Web site, wherein the crawling bot defines a session state representing a user state for interacting with one or more Web sites, a set of conditions, and a set of scenarios to be selectively activated based on whether the set of conditions are satisfied or not, wherein said set of conditions includes a state condition for whether the user state is equal to a preconfigured value or not, and wherein said set of conditions includes a content matching condition;
the crawling bot, via at least one processor executing program instructions of the crawling bot where the program instructions are stored on at least one storage device, receiving content from the Web site during the interactive session;
the crawling bot, via at least one processor executing program instructions of the crawling bot where the program instructions are stored on at least one storage device, parsing the content from the Web site, and matching the parsed content against a previously defined set of items to determine whether the content matching condition is satisfied or not; and
if the content matching condition is satisfied and if the state condition is satisfied, the crawling bot, via at least one processor executing program instructions of the crawling bot where the program instructions are stored on at least one storage device, activating one of the scenarios defined by the crawling bot, which is not activated by the crawling bot when the content matching condition and the state condition are not satisfied.

2. The method of claim 1, wherein said session state comprises at least two different states, one state indicating that an entity is logged onto the Web site and another state indicating that the entity is not logged onto the Web site.

3. The method of claim 1, wherein the Web site provides dynamic content, wherein the set of conditions indicate a Web site state relevant to the dynamic content, and wherein the activated one of the scenarios provides previously defined input from the crawler bot to the Web site specific to the Web site state to effectuate a change in the dynamic content of the Web site.

4. The method of claim 1, wherein each of the set of scenarios comprises a predefined set of pre-interaction characteristics, a predefined set of interactions, a predefined set of post-interaction characteristics, and a predefined set of states, wherein each of the predefined set of states is associated with one or more of the post-interaction characteristics.

5. The method of claim 1, further comprising:
upon activating the one scenario, performing upon a current object of the Web site during the interactive session each of a plurality of interactions in a predefined set of interactions associated with the scenario;
identifying which of a set of characteristics in a predefined set of post-interaction characteristics associated with the scenario are present during the crawling session subsequent to performing the interactions; and
determining a current state of the interactive session as being a predefined state that is associated with any of the post-interaction characteristics that are present during the interaction session subsequent to performing the interactions.

6. The method of claim 1, wherein the Web site represents a Web application, which is being crawled by the crawling bot during the interaction session.

7. A method comprising:
selecting a predefined scenario where each of the characteristics in a predefined set of pre-interaction characteristics associated with the scenario is present at a point during a crawling session;
performing upon a current object of the crawling session each of the interactions in a predefined set of interactions associated with the scenario;
identifying which of the characteristics in a predefined set of post-interaction characteristics associated with the scenario are present during the crawling session subsequent to performing the interactions; and
determining a current state of the crawling session as being a predefined state that is associated with any of the post-interaction characteristics that are present during the crawling session subsequent to performing the interactions.

8. The method of claim 7, wherein the crawling session is an interactive session of between an autonomous software application referred to as a crawling bot that navigates to a Web site and traverses its content, providing indexed information regarding the Web site.

9. The method of claim 7, wherein the predefined scenario comprises the predefined set of pre-interaction characteristics, the predefined set of interactions, the predefined set of post-interaction characteristics, and a predefined set of states, wherein each of the predefined set of states is associated with one or more of the post-interaction characteristics, wherein the predefined scenario is selectively activated by a crawl bot and are defined by the crawl bot for interactions with content on the Web, which the crawl bot is designed to crawl.

10. The method of claim 7, wherein said predefined state comprises at least two different states, one state indicating that an entity is logged onto the Web site and another state indicating that the entity is not logged onto the Web site.

11. The method of claim 7, wherein the crawling session is between an autonomous software entity and a Web site, wherein the Web site provides dynamic content, wherein a set of conditions handled by the software entity indicate a Web site state relevant to the dynamic content, and wherein the predefined scenario provides previously defined input from the software entity to the Web site specific to the Web site state to effectuate a change in the dynamic content of the Web site.

12. The method of claim 7, wherein the selecting includes selecting where any of the characteristics in the predefined set of pre-interaction characteristics is present in the current object of the crawling session.

13. The method of claim 7, wherein the selecting includes selecting where any of the characteristics in the predefined set of pre-interaction characteristics is present in state information that is maintained of the crawling session.

14. The method of claim 7, wherein the selecting, performing, identifying, and determining are performed when crawling a web application.

15. The method of claim 14, wherein the selecting is performed after receiving a web page from a web application.

16. The method of claim 15, wherein the performing comprises performing each of the interactions with the web page.

17. The method of claim 7, wherein the identifying comprises identifying any of the post-interaction characteristics within any responses elicited by the interactions.
